(19) United States
(12) Patent Application Publication
(10) Pub. No.: US 2015/0040055 A1
(43) Pub. Date: Feb. 5, 2015

(54) DYNAMIC SOFT KEYBOARD FOR TOUCH SCREEN DEVICE

(71) Applicants: Bowen Zhao, Shanghai (CN); Chenliang Huang, Shanghai (CN)

(72) Inventors: Bowen Zhao, Shanghai (CN); Chenliang Huang, Shanghai (CN)

(21) Appl. No.: 13/997,343

(22) PCT Filed: Jun. 7, 2011
(86) PCT No.: PCT/CN2011/000949

§ 371 Date: Apr. 4, 2014

(51) Int. Cl. G06F 3/023; G06F 17/27; G06F 3/0488

(52) U.S. Cl. CPC G06F 3/0237; G06F 3/04886; G06F 17/276
USPC 715/773

(57) ABSTRACT

In a processing system having a touch screen display, a method and apparatus for dynamically updating a soft keyboard shown on the touch screen display. The method includes receiving user input data from a user. When the user input data indicates a current character, predicting a likelihood of at least one next character being entered by the user, and assigning the at least one next character to a soft key of the soft keyboard based at least in part on a correlation of the likelihood of the at least one next character being entered next by the user and a distance of the soft key to a predetermined location of the soft keyboard. The soft keyboard may then be updated on the touch screen display.

### FIELD

The present disclosure generally relates to the field of graphical user interfaces (GUIs) in processing systems. More particularly, an embodiment of the invention relates to a soft keyboard for a touch screen device of a processing system.

### BACKGROUND

Some processing systems have touch screen displays that accept user input by sensing touching of the screen or by sensing a user's finger or hand in close proximity to the touch screen. Such touch screens are popular with portable processing systems with relatively small displays such as smart phones and tablet computers. Touch screens often use the concept of a “soft keyboard.” That is, the keys of a keyboard are represented as specific areas of the touch screen rather than physical plastic keys. However, current touch screen soft keyboards usually have the keys laid out in a fixed pattern. For a processing system supporting an English language user in the United States, the fixed pattern is typically substantially similar to the “QWERTY” keyboard pattern designed in 1873. Alternating hands while typing is a desirable trait in a keyboard design, since while one hand is typing a letter, the other hand can get in position to type the next letter. Thus, a typist may fall into a steady rhythm and type quickly. However, when a string of letters is done with the same hand, the chances of stuttering are increased and a rhythm can be broken, thus decreasing speed and increasing errors and fatigue. In the QWERTY layout, many more words can be spelled using only the left hand than the right hand. In fact, thousands of English words can be spelled using only the left hand, while only a couple of hundred words can be typed using only the right hand. In addition, most typing strokes are done with the left hand in the QWERTY layout. This is helpful for left-handed people but is to the disadvantage of right-handed people. However, left-handed people make up only approximately 10% of the world's population, so this approach is inefficient for most people.

Furthermore, with the widespread popularity of texting on a smart phone, some users may incur repetitive stress injuries from making the same larger scale thumb or finger movements.

Thus, a better and more efficient approach to providing a soft keyboard in a processing system is desired.

### BRIEF DESCRIPTION OF THE DRAWINGS

The detailed description is provided with reference to the accompanying figures. The use of the same reference numbers in different figures indicates similar or identical items.

FIG. 1 is a diagram of a processing system according to an embodiment of the present invention.

FIG. 2 is a diagram of a user input control component according to an embodiment of the present invention.

FIGS. 3 through 7 are diagrams of example dynamic soft keyboard displays according to an embodiment of the present invention.

FIG. 8 is a flow diagram of user input control processing according to an embodiment of the present invention.

FIGS. 9 and 10 illustrate block diagrams of embodiments of processing systems, which may be utilized to implement some embodiments discussed herein.

### DETAILED DESCRIPTION

Embodiments of the present invention overcome deficiencies in existing processing systems relating to touch screen input processing by dynamically adjusting the layout of a soft keyboard during use. By dynamically adjusting the layout of the soft keyboard, a user may input data easier, faster, and with less physical strain than with prior approaches.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs stored on a computer readable storage medium (“software”), or some combination of hardware and software. For the purposes of this disclosure reference to “logic” shall mean either hardware, software (including for example micro-code that controls the operations of a processor), firmware, or some combination thereof.

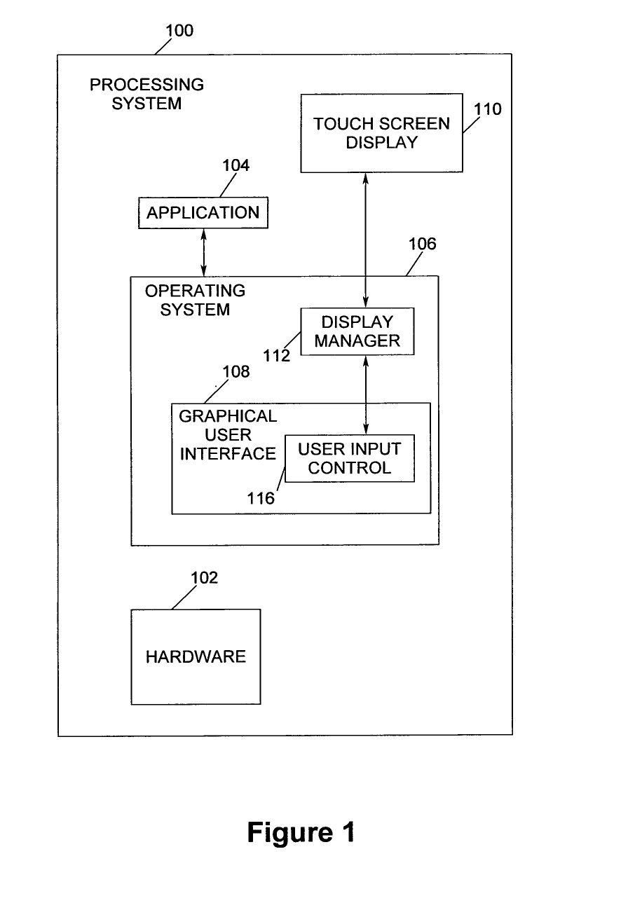

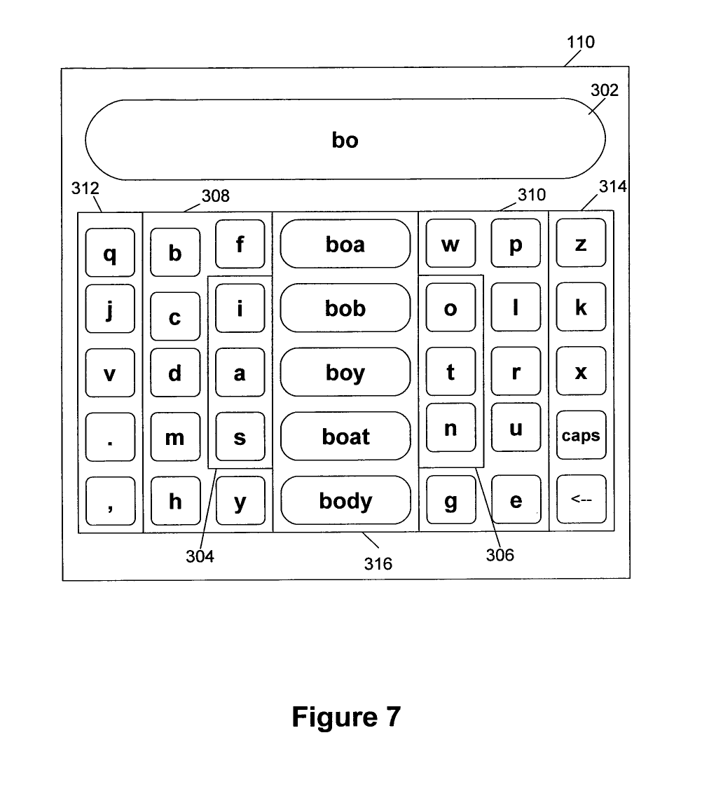

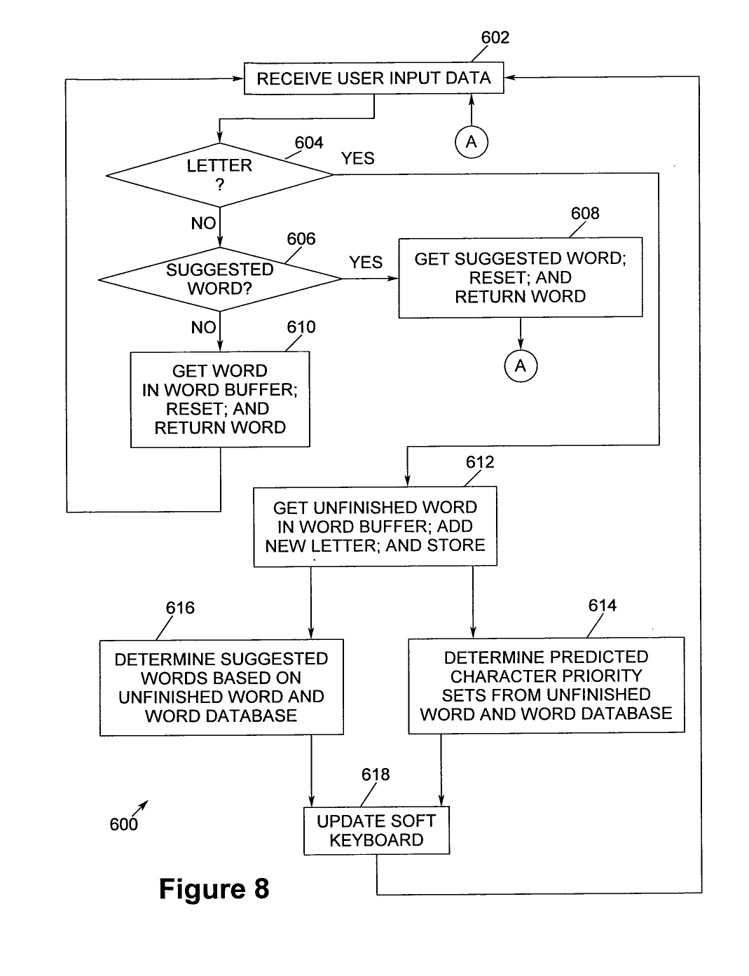

FIG. 1 is a diagram of a processing system according to an embodiment of the present invention. In various embodiments, processing system 100 may be a smart phone, a personal computer (PC), a laptop computer, a netbook, a tablet computer, a handheld computer, a mobile Internet device (MID), or any other stationary or mobile processing device. As shown in the simplified diagram of FIG. 1, processing system 100 comprises hardware 102 (which will be further discussed with reference to FIGS. 7 and 8). Application 104 may be any application program to be executed on the processing system. In various embodiments, the application program may be a standalone program for performing any function, or a part of another program (such as a plug-in, for example), for a web browser, image processing application, game, or multimedia application, for example. Operating system (OS) 106 interacts with application 104 and hardware 102 to control the operation of the processing system as is well known. OS 106 comprises a graphical user interface (GUI) 108 to manage the interaction between the user and various input and output devices. Processing system 100 comprises multiple known input and output devices (not shown). Touch screen display 110 may be included in the system to display output data to the user as well as to accept input signals from the user via the touch screen. In an embodiment, the OS may include a display manager component 112 to manage the input data from and the output data to the touch screen display 110. In an embodiment, display manager component 112 controls the display of a soft keyboard on the touch screen display.

In an embodiment, GUI 108 comprises user input control component 116 to analyze the input data received from the touch screen display. User input control component 116 may receive input data, either directly or indirectly, from touch screen display 110 via display manager 112. In an embodiment, user input control component 116 may cause the display manager 112 to dynamically change the layout of the soft keyboard on the touch screen display during use by the user.

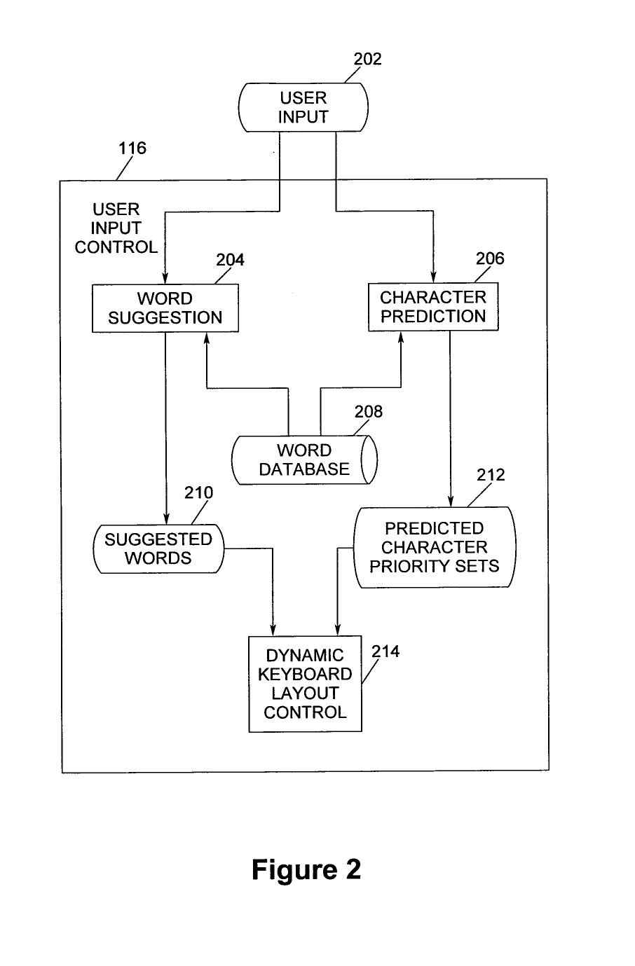

FIG. 2 is a diagram of user input control component 116 according to an embodiment of the present invention. User input 202 comprises data representing the sensing of at least one soft key by the touch screen display. The touching of the soft key represents a character in a character set. In one embodiment, the character set may be the Latin alphabet, and include the letters used in the English language, numbers, and special characters. In other embodiments, other similar alphabets for other languages may be implemented, such as French, German, Dutch, etc., as well as for languages having other alphabets such as Cyrillic, Greek, Hebrew, Hangul, Arabic, and so on. In other embodiments, at least a subset of a logographic script such as Chinese or Japanese characters may be used as a selected character set. In an embodiment, a language and/or a character set may be selected by the user for use with the processing system. In one embodiment, the processing system may support multiple languages and character sets, and the user may change his or her selection of language and/or character set to be used at any time. Regardless of the selected language or alphabet, for each character input, user input control 116 processes the character using character prediction component 206 and word suggestion component 204. Each character input may be denoted as the current character while being processed.

Character prediction component 206 determines a priority for a next possible character to be input by the user based at least in part on one or more of the current character, the frequency of use of characters in the selected language (English in this example), a word database 208, and the validity of the combination of the current character and the next possible character in the selected language. Word database 208 comprises a list of words of the language(s) supported by the processing system. The number of words in the word database and the languages supported are implementation dependent. Information relating to character combinations may be obtained from word database 208. Information relating to the frequency of use of characters may be stored in character prediction component 206 or may be obtained from the word database 208, depending on the implementation.

In an embodiment, for a first character input, a list of the frequency of characters used as a first character of words in the selected language may be consulted. In an embodiment, there may be a first character frequency list for each supported language. In an embodiment, for characters input subsequent to the first character of a word, a list of the general frequency of characters used in words of the selected language may be consulted. In an embodiment, there may be a general character frequency list for each supported language. In another embodiment, the frequency of characters for a first character of a word and/or subsequent characters of a word may be determined based only on the words stored in the word database for the selected language rather than all of the words of the selected language.

In an embodiment, there may be three priorities determined for each input opportunity: a first priority set of the characters in the character set most likely to follow the current character; a second priority set of the characters in the character set next most likely to follow the current character; and a third priority set of characters in the character set least likely to follow the current character. In one embodiment supporting the 26 letters in the English language, the first priority set may include six letters, the second priority set may include 14 letters, and the third priority set may include six letters. Other priority sets may be defined for numbers, punctuation, and special characters. In other embodiments, other numbers and sizes of priority sets may be implemented. For other supported languages, other numbers and sizes of priority sets may be implemented as appropriate based on the specific rules and usage of the supported languages.

For a first character input for a word, character prediction component 206 may determine the characters for each of the priority sets by referencing the first character frequency list for the selected language. In one embodiment, for each subsequent character input for the word, character predication component 206 references words of the word database 208 beginning with previously input characters of the current word, and determines the likelihood of the character to be input next by the user based at least in part on the frequency of the combination of the first character and the subsequent character(s) in the word database. In another embodiment, for each subsequent character input for the word, the character predication component references the general frequency list of characters for the selected language, and determines the likelihood of the character to be input next by the user based at least in part on the frequency of usage of the subsequent character(s) in the word database and/or the validity of the first character and subsequent character combination in the language. The likelihood of the subsequent character may be used in determining the predicted character priority sets 212.

In one embodiment, dynamic keyboard layout control component 214 accepts the predicted character priority sets and dynamically rearranges the soft keyboard on the touch screen display after each user input based at least in part on the predicted character priority sets. In an embodiment, the dynamic keyboard layout control component 214 rearranges the display of the soft keys of the soft keyboard after each user input according to a correlation such that the soft keyboard always has the characters most likely to be entered next by the user closest to a predetermined location (such as the center) of the soft keyboard, and characters least likely to be entered next by the user are farthest from the location (such as the center) of the soft keyboard.

In an embodiment, soft keys representing characters of a first predicted character priority set may be of a different size than soft keys representing characters of a second predicted character set. In one embodiment, soft keys representing characters of the first predicted character set may be larger than soft keys representing characters of the second predicted character set. Similarly, soft keys representing characters of the second predicted character set may be larger than soft keys representing characters of the third predicted character set. Thus, characters that are more likely to be entered by the user are represented as larger soft keys, so they are easier to find and select on the soft keyboard.

User input 202 may also be sent to word suggestion component 204. Word suggestion component determines a set of suggested words 210 that the user may be trying to enter into the processing system based at least in part on the characters already entered for the current word and the word database 204. In an embodiment, suggested words may be displayed on the touch screen along with the soft keyboard. This allows a user to start typing the first one or two or more characters of a word and then select one of the displayed suggested words for entry into the processing system instead of typing each character of the desired word. Suggested words 210 comprises one or more words and/or word fragments.

For each word, initially no characters have yet been input. In this instance, in one embodiment, word suggestion component 204 selects the most frequently used words of the language from the word database and displays these words on the touch screen as suggested words 210. In an embodiment, the most frequently used words selected may be different depending on which user is currently using the processing system. That is, the most frequently used words list may be customized for a given user. In an embodiment, word suggestion component 204 determines a set of most likely words from the word database to be used by the user and displays these words on the touch screen as suggested words 210. The most likely words may be determined based on a selected policy. The number of suggested words 210 displayed is implementation dependent.

In another scenario, the user may have input at least one word but no characters yet of the current word. In one embodiment, the word suggestion component determines suggested words 210 based at least in part on the previous one or more words in a sentence entered by the user and the word database. In one embodiment, the word suggestion component determines which words of the word database are most likely to be entered by the user after the previously entered word(s). In another scenario, the user may have already entered one or more characters of a current word. In this case, in one embodiment, the word suggestion component determines the words (and/or fragments of words) from the word database that match the characters already entered for the current word and selects at least a subset of those words as suggested words 210.

In one embodiment, the determination of suggested words may be adapted over time to reflect the prior usage of words by the current user of the processing system. That is, vocabulary usage of the user may be updated in entries for the words of the word database and may affect future determination of suggested words. The user's frequently used words may also include acronyms, friend's names, family member's names, popular place names, and so on. In one embodiment where the characters are being entered into an instant messaging application, the suggested words may be determined by taking into account the intended recipient of the message being typed by the user. For example, if the user is typing an instant message to a friend, one set of suggested words may be determined at any point in the text entry process. If the user is typing an instant message to a family member, a different set of suggested words may be determined.

Dynamic keyboard layout control component 214 accepts the suggested words and causes the display of the suggested words in the appropriate portion of the soft keyboard or other desired location on the touch screen display. In an embodiment, the dynamic keyboard layout control component causes the update of the display of the suggested words after each character is input by the user. If and when the user selects a suggested word as a desired word for input to the processing system, the user input will reflect the selection of one of the suggested words and this information may be captured by the display manager 112 and/or the user input control component 116, without the user having to enter all characters of the desired word. In this case, the selected suggested word replaces characters entered by the user of the current word fragment.

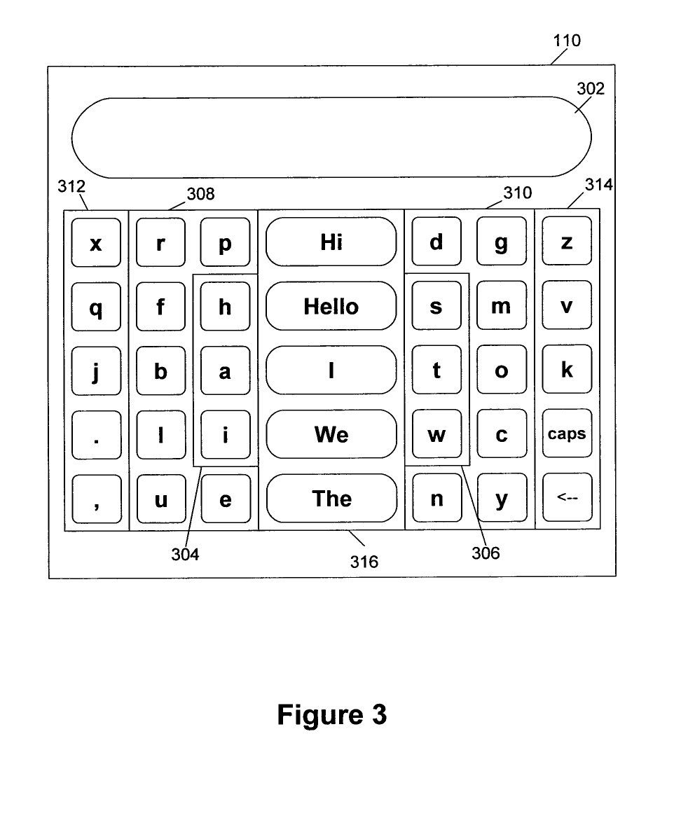

FIGS. 3 through 7 are diagrams of example dynamic soft keyboard displays according to an embodiment of the present invention. FIG. 3 is an example of a soft keyboard shown on a touch screen display 110 prior to the user entering any characters. In this example, a user input entry portion 302 may be used to display characters that the user enters as they are being entered. Initially, this portion may be blank. In this example embodiment, three predicted character priority sets may be shown on the display in an arrangement as determined by the dynamic keyboard layout control component 214. In this example, the three predicted character priority sets collectively include the 26 letters of the English alphabet sorted in order of frequency of use as first letters of English words. In one dataset, this order is {t, a, s, h, w, I, o, b, m, f, c, l, d, p, e, g, r, y, u, k, j, v, q, z, and x}. In other embodiments supporting other languages and/or alphabets, a different sequence of characters appropriate to the language and/or alphabet may be used in the predicted character priority sets.

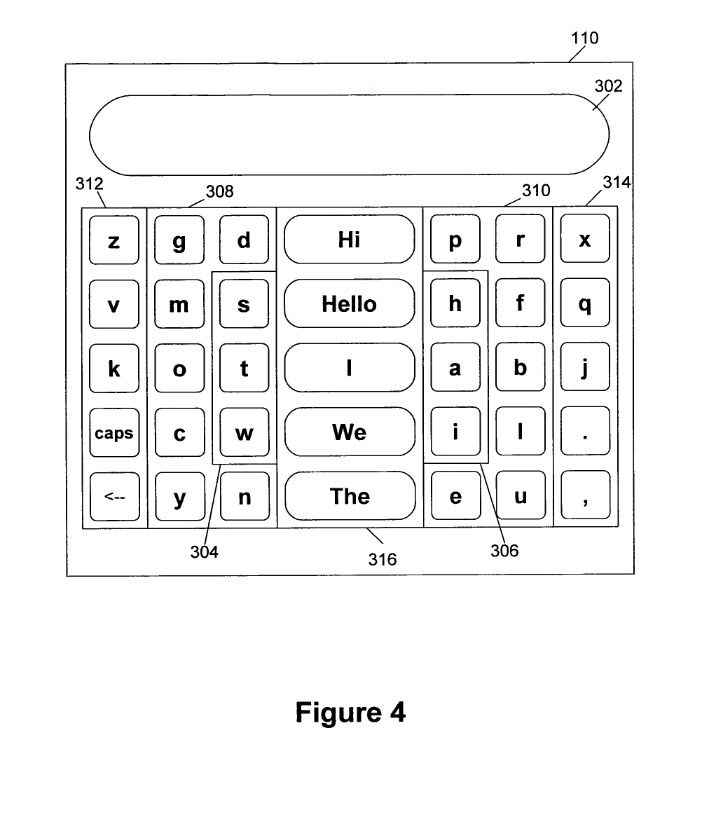

In an embodiment, a first predicted character priority set may be shown within portions 304 and 306. In one embodiment, the first predicted character priority set may be divided, with a first subset being shown on the left hand side of the center column at 304, and a second subset being shown on the right hand side of the center column at 306 (with the elements of the first subset being different than the elements of the second subset). As arranged in FIG. 3, the user's left hand may easily select the first subset 304 of soft keys and the user's right hand may easily select the second subset 306 of soft keys. In one embodiment, where no characters have yet been input, the first and second subsets may include the six most frequently used characters for first letters of a word in the selected language. In an example where the selected language is English, the six letters are (t, a, s, h, w, and i, in descending order of frequency of use. For efficiency purposes, in one embodiment, the most frequently used first letter “t” of the first predicted character priority set is shown in the soft key closest to a predetermined location (such as the center) of the soft keyboard for the user's right hand (since 90% of the population is right handed). In this example soft keyboard layout, the center of the soft keyboard shows a soft key with the word “I”. The next most frequently used first letter “a” is shown in the soft key closest to the center for the user's left hand. In similar fashion, the remaining four is, h, w, and i) of the six most frequently used first letters are assigned soft keys in relative priority order around the center of the soft keyboard in portions 304 and 306 as shown. In an embodiment, the selection of letters from the first predicted priority set alternates between right hand portion 306 and left hand portion 304 of the soft keyboard for assignment to soft keys. In this embodiment, the bias of arranging the characters on the soft keyboard is for a right-handed user (as shown in FIG. 3). In another embodiment, this bias of arranging the characters on the soft keyboard for the first predicted character priority set may be reversed for a left-handed user (that is, the most frequently used characters may be assigned to the first subset 304 and so on), as shown in FIG. 4.

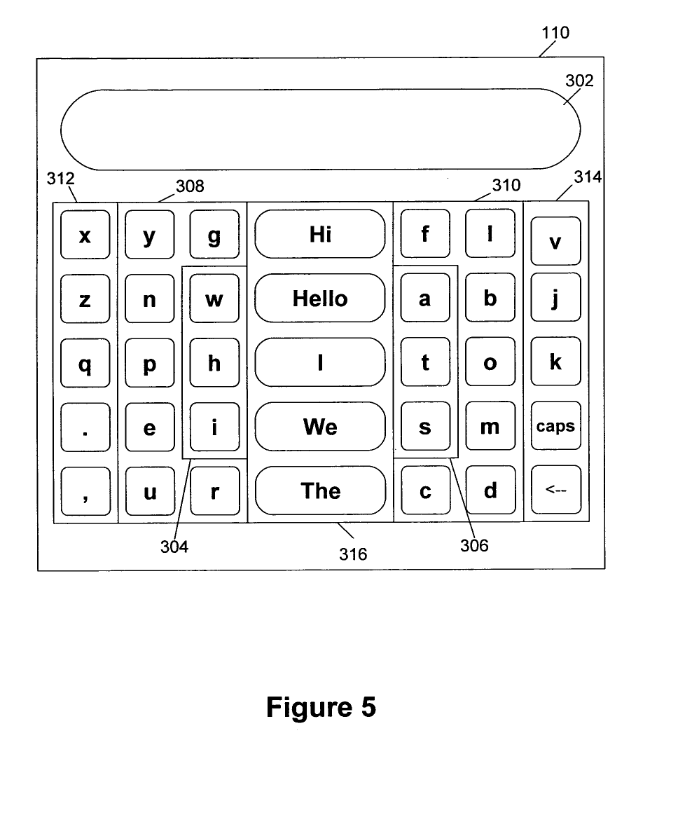

In another embodiment, the division of the subsets may be different. In this embodiment, the second subset 306 may include the first three most frequently used characters (e.g., t, a, and s) and the first subset 304 may include the next three most frequently used characters (e.g., h, w, and i), with no alternating between subsets. In some circumstances, this arrangement may better support a right-handed user than the alternating arrangement of FIG. 3. This new arrangement is shown in FIG. 5. In another embodiment supporting a left-handed user, the first subset may include the first three most frequently used characters and the second subset may include the next three most frequently used characters.

A second predicted character priority set may also be divided, with a third subset being shown on the left hand side of the center column at 308, and a fourth subset being shown on the right hand side of the center column at 310 (with the elements of each of the first, second, third and fourth subsets being different than the elements of the other subsets). As arranged in FIG. 3, the user's left hand may easily select the third subset 308 of soft keys and the user's right hand may easily select the fourth subset 310 of soft keys. In one embodiment, where no characters have yet been input, the third and fourth subsets may include the 14 next most frequently used characters for first characters of a word in the selected language. In an example where the language is English, the 14 letters are {o, b, m, f, c, l, d, e, g, r, y, and u}, in descending order of frequency. For efficiency purposes, in one embodiment, the most frequently used first letter “o” of the second predicted character priority set is shown in the remaining unassigned soft key of the right hand portion 310 of the soft keyboard closest to a predetermined location (such as the center) of the soft keyboard for the user's right hand. The next most frequently used first letter “b” is shown in the remaining unassigned soft key of the left hand portion 308 of the soft keyboard closest to the center for the user's left hand. In similar fashion, the remaining 12 {c, l, d, e, g, r, y, and u} of the 14 next most frequently used first letters are assigned soft keys in relative priority order around the center of the soft keyboard as shown.

In an embodiment, the selection of letters from the second predicted character priority set alternates between right hand portion 310 and left hand portion 308 of the soft keyboard for assignment to soft keys. In this embodiment, the bias of arranging the characters on the soft keyboard is for a right-handed user. In another embodiment, this bias of arranging the characters on the soft keyboard for the second predicted character priority set may be reversed for a left-handed user (that is, assign the next most frequently used character to the third subset 308 and so on).

In another embodiment, the division of the subsets may be different. In this embodiment, the fourth subset 310 may include the first most frequently used characters of the second predicted character priority set (e.g., o, b, m, f, c, l, and d) and the third subset 308 may include the remaining most frequently used characters (e.g., d, p, e, g, r, y, and u), with no alternating between subsets. This arrangement would support a right-handed user. In another embodiment supporting a left-handed user, the third subset may include the next most frequently used characters and the fourth subset may include the remaining most frequently used characters.

In an embodiment, a third predicted character priority set may be shown within portions 312 and 314. In one embodiment, the third predicted character priority set may be divided, with a fifth subset being shown on the left hand side of the center column at 312, and a sixth subset being shown on the right hand side of the center column at 314 (with the elements of the each subset being different than the elements of the all other subsets). As arranged in FIG. 3, the user's left hand may select the fifth subset 312 of soft keys and the user's right hand may select the sixth subset 314 of soft keys. In one embodiment, where no characters have yet been input, the fifth and sixth subsets may include the six least frequently used characters for first characters of a word in the selected language. In an example where the supported language is English, the six letters are {k, j, v, q, z, and x}, in descending order of frequency of use. For efficiency purposes, in one embodiment, the most frequently used first letter “k” of the third predicted character priority set is shown in the remaining unassigned soft key of the right hand portion 314 of the soft keyboard closest to a predetermined location (such as the center) of the soft keyboard for the user's right hand. The next most frequently used first letter “j” is shown in the remaining unassigned soft key of the left hand portion 312 of the soft keyboard closest to the center for the user's left hand. In similar fashion, the remaining four {v, q, z, and x} of the six least frequently used first letters are assigned soft keys in relative priority order around the center of the soft keyboard in portions 312 and 314 as shown.

In an embodiment, the selection of letters from the third predicted character priority set alternates between right hand portion 314 and left hand portion 310 of the soft keyboard for assignment to soft keys. In this embodiment, the bias of arranging the characters on the soft keyboard is for a right-handed user. In another embodiment, this bias of arranging the characters on the soft keyboard for the third predicted character priority set may be reversed for a left-handed user (that is, assign the next most frequently used character to the fifth subset 312 and so on).

In another embodiment, the division of the subsets may be different. In this embodiment, the sixth subset 314 may include the three most frequently used characters of the third predicted character priority set (e.g., v, k, and j) and the fifth subset 312 may include the remaining characters (e.g., x, q, and z), with no alternating between subsets. This arrangement would support a right-handed user. In another embodiment supporting a left-handed user, the fifth subset may include the next most frequently used characters and the sixth subset may include the remaining characters.

In this example soft keyboard layout, four extra soft keys are shown for a period, a comma, a caps selection, and an enter arrow. In various embodiments, other characters may be shown.

Note that the distance to the center of the soft keyboard of the soft keys assigned to the first predicted character priority set is generally less than or equal to the distance to the predetermined location (such as the center) of the soft keyboard of the soft keys assigned to the second predicted character priority set, and the distance to the predetermined location (such as the center) of the soft keyboard of the soft keys assigned to the second predicted character priority set is generally less than or equal to the distance to the predetermined location (such as the center) of the soft keyboard of the soft keys assigned to the third predicted character priority set. In other embodiments, different numbers of character priority sets may be used (e.g., only two character priority sets, four character priority sets, and so on), depending on the implementation requirements.

Regardless of however many character priority sets are used, in embodiments of the present invention, dynamic assignment of characters to soft keys may be determined based at least in part on a correlation of the likelihood of use of the characters and the distance of the soft keys to a predetermined location (such as the center) of the soft keyboard.

In an embodiment of the present invention, a suggested words portion 316 of the soft keyboard may be shown in the center column. In this example, frequently used words may be shown as suggested words 210 determined by word suggestion component 204. In this example, five words are shown {Hi, Hello, I, We, and The}. In various embodiments, different numbers of suggested words may be shown. In one embodiment, where no word has yet been input, the initial suggested words may be the most frequently used words of the selected language. In another embodiment, the initial suggested words may be the most frequently used words previously entered by the current user. In another embodiment, in response to an action by the user, the user input control component 116 may cause the display of additional suggested words on the touch screen display to give the user more choices for possible words to select.

In various embodiments the particular arrangement of portions of the soft keyboard shown in FIG. 3 may be changed depending on implementation requirements. For example, the user input entry portion may be located at the bottom or one of the sides of the soft keyboard. The suggested words may be shown on the top, sides or bottom of the soft keyboard rather than in the center column. There may be different numbers of left and right hand portions, and different numbers of predicted character priority sets.

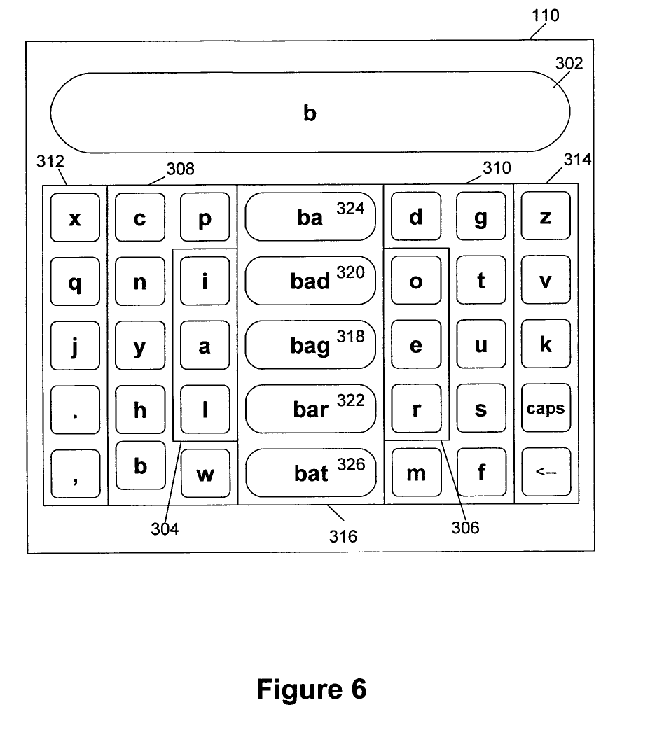

FIG. 6 is a diagram of the example dynamic soft keyboard display of FIG. 3 according to an embodiment of the present invention after one character has been input by the user. In this example, the first character entered by the user is a “b”. The “b” character entered is shown in the user input entry portion 302 of the touch screen display. After the “b” is received, character prediction component 206 determines the arrangement of the soft keys to be displayed in response. In the current example using the English language, the character prediction component uses a general frequency of characters in English. In this example, the three predicted character priority sets collectively include the 26 letters of the English alphabet sorted in order of general frequency of use as any letter in English words. In one dataset, this order is {e, t, a, o, I, n, s, h, r, d, l, c, u, m, w, f, g, y, p, b, v, k, j, x, q, and z}. In other embodiments supporting other languages and/or alphabets, a different sequence of characters appropriate to the language and/or alphabet will be used in the predicted character priority sets.

In one embodiment, the arrangement of the soft keys may follow the arrangement as shown and discussed above for FIG. 3, except the frequency data used is the general frequency of use dataset for the selected language instead of the first letter frequency of use dataset. In one embodiment, this arrangement may be modified by taking into account valid and invalid character combinations in the selected language. For example, the letter “t” might ordinarily be in the first predicted character priority set after the entry of one character such as “b” by the user. However, in this example the character combination “bt” is invalid in English. No English words start with “bt”. The character combination “bt” may form an acronym or a fragment of an acronym. But this may be less likely for the user to be entering than a valid character combination. Thus, in an embodiment, the letter “t” may be included in the second or third predicted character priority set instead of the first predicted character priority set. Character prediction component 206 determines the predicted character priority sets at each user input based at least in part on invalid or valid character combinations as well as general frequency of use. In this example, only the letters {e, a, o, i, r, l, u, and y} are valid for coming after a “b” in normal English usage.

In this example, after processing the entry of the letter “b”, the character prediction component determines that the first predicted character priority set includes {e, a, o, i, r, and l}; the second predicted character priority set includes {u, y, t, n, s, h, d, p, m, w, f, and b}; and the third predicted character priority set includes {k, j, v, q, z, and x}. The predicted character priority sets may be assigned to soft keys as shown in FIG. 6. As discussed above with reference to FIGS. 4 and 5, this arrangement may be modified for use by a left-handed user, and/or to be non-alternating between expected right and left hand use.

Word suggestion component 204 determines the words to be shown as suggested words 210 based at least in part on the entry of the letter “b” and the word database 208. In this example, the touch screen now displays the words and/or word fragments {ba, bad, bag, bar, and bat} as shown in FIG. 6. In an embodiment, the suggested words may be arranged such that the most likely word or word fragment to be entered next is shown in the center portion 318 of the suggested words area 316 of the touch screen, the next most likely in the next highest portion 320, the second next most likely in the next lower portion 322, the third next highest in the highest portion 324, and the fourth next highest in the lowest portion 326. In other embodiments, other arrangements may be used.

FIG. 7 is a diagram of the example dynamic soft keyboard display of FIG. 6 according to an embodiment of the present invention after another character has been input by the user. In this example, the additional character entered by the user is an “o”. The “bo” character combination entered is now shown in the user input entry portion 302 of the touch screen display. After the “bo” is received, character prediction component 206 determines the arrangement of the soft keys to be displayed in response to this character combination. In the current example using the English language, the character prediction component uses a general frequency of characters in English.

In one embodiment, the arrangement of the soft keys may follow the arrangement as shown and discussed above for FIG. 3, except the frequency data used is the general frequency of use dataset for the selected language instead of the first letter frequency of use dataset. In one embodiment, this arrangement may be modified by taking into account valid and invalid character combinations in the selected language. Character prediction component 206 determines the predicted character priority sets after each user input based at least in part on invalid or valid character combinations as well as general frequency of use of the character combinations.

In this example, after processing the entry of the letters “bo”, the character prediction component determines that the first predicted character priority set includes {t, a, o, i, n, and s}; the second predicted character priority set includes {r, d, l, c, u, m, w, f, g, y, p, b, e, and h}; and the third predicted character priority set includes {x, v, k, j, z, and q}. The predicted character priority sets may be assigned to soft keys as shown in FIG. 7. As discussed above with reference to FIGS. 4 and 5, this arrangement may be modified for use by a left-handed user, and/or to be non-alternating between expected right and left hand use.

Word suggestion component 204 determines the words to be shown as suggested words 316 based at least in part on the entry of the letters “bo” and the word database 208. In this example, the touch screen now displays the words and/or word fragments (boa, bob, boy, boat, body) as shown in FIG. 7.

Processing similar to that discussed above may be repeated for every subsequent user input.

In an embodiment, the arrangement of the soft keys may be updated at a frequency less than every user input. In one embodiment, the arrangement of soft keys may be set and remain in the order of frequency of use for first letters as shown in FIG. 3, 4 or 5. In order to decrease the cognitive load on a user when typing a message, in another embodiment the arrangement of the soft keys may be updated after entry of every word, every sentence, or every message. In another embodiment, the arrangement of the soft keys may be periodically determined for the user based on the user's vocabulary as stored and updated in the word database. In another embodiment, the user may decide that he or she likes a particular arrangement of soft keys and may instruct the user input control component at any time to save and display the desired arrangement as the user's default preference whenever the user uses the processing system. In this scenario, a compromise between improving efficiency and decreasing cognitive load may be obtained.

FIG. 8 is a flow diagram of user input control processing 600 according to an embodiment of the present invention. At block 602, user input data 202 may be received by the user input control component 116. First, at decision block 604, a determination is made as to whether the user input data is a character representing a letter (for example, when the selected language is English or another language having an alphabet). If not, at decision block 606, a determination is made as to whether the user input data indicates a suggested word. If the user input data is not a character representing a letter or indicating a suggested word, then at block 610 the current word stored in a data storage location called a word buffer may be obtained, word suggestion component 204 and character prediction component 206 may be reset, the soft keyboard may be reset, and the current word may be returned. The word buffer may be used to store an unfinished or finished word in a storage location accessible to the user input control component. Further processing may be performed when user input data is again received at block 602. If the user input data does indicate a suggested word at block 604, the suggested word indicated by the user input data may be obtained, word suggestion component 204 and character prediction component 206 may be reset, the soft keyboard may be reset, and the suggested word may be returned. Further processing may be performed when user input data is again received at block 602.

If the user input data is a character representing a letter at block 604, then at block 612, the unfinished word may be obtained from the word buffer, the new character added to the end of the unfinished word, and the unfinished word may be stored in the word buffer. At block 614, character prediction component 206 determines the predicted character priority sets 212 based at least in part on the unfinished word and the word database 208. In one embodiment, character prediction component processing may be performed as follows. An unfinished word may be obtained from the word buffer. All words from the word database which start with the unfinished word may be selected. These words may be sorted and grouped together according to the next character in the word immediately after the unfinished word. The groups of selected words may be sorted according to specified criteria. In an embodiment, the specified criteria results in an indication of the likelihood that the next character would be entered by the user as the next character in the unfinished word. The possible next characters may be sorted in a priority order and grouped to form the predicted character priority sets 212.

At block 616, word suggestion component 204 determines the suggested words 210 based at least in part on the unfinished word and the word database 208. In one embodiment, word suggestion component 204 processing may be performed as follows. An unfinished word may be obtained from the word buffer. All words from the word database which start with the unfinished word may be selected. These words may be sorted based at least in part on the frequency of use of the selected words. At least a subset of the sorted selected words may be returned as the suggested words.

At block 618, dynamic keyboard layout control component 214 updates the suggested words displayed on the soft keyboard on the touch screen, and updates the soft key assignments of the soft keyboard according to the predicted character priority sets. In one embodiment, the new predicted character priority sets may be compared to the previous predicted character priority sets. In an embodiment, the new predicted character priority sets may be used to first update the first predicted character priority set, then the second predicted character priority set, and finally the third predicted character priority set. In an embodiment, if a character priority is unchanged from a previous iteration, the soft key may keep its current character assignment. In this scenario, only soft keys where the character assignment has changed may be modified.

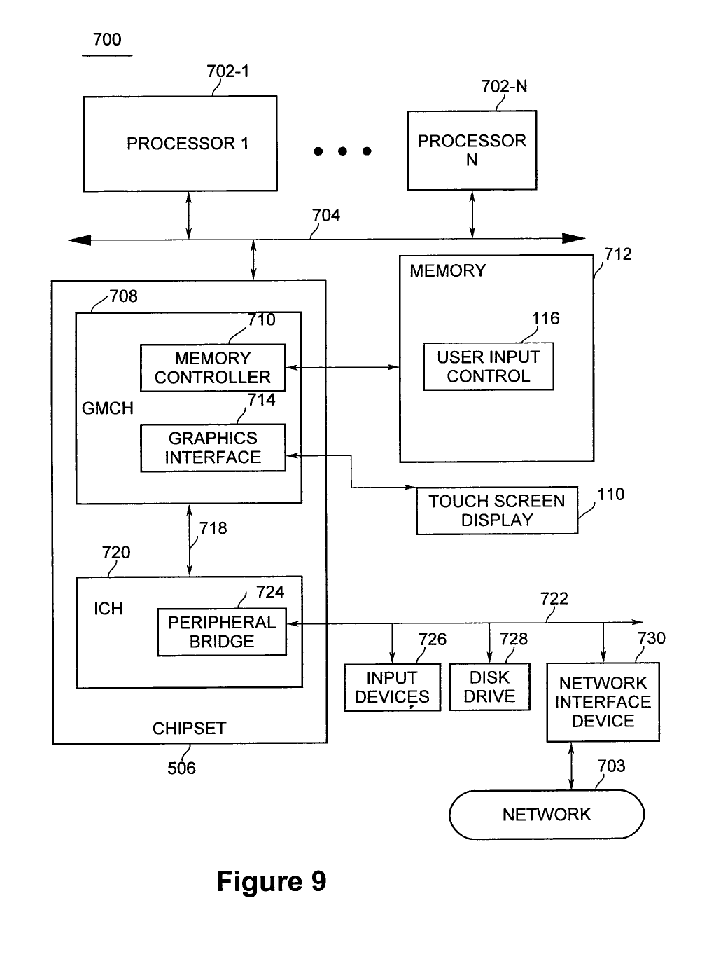

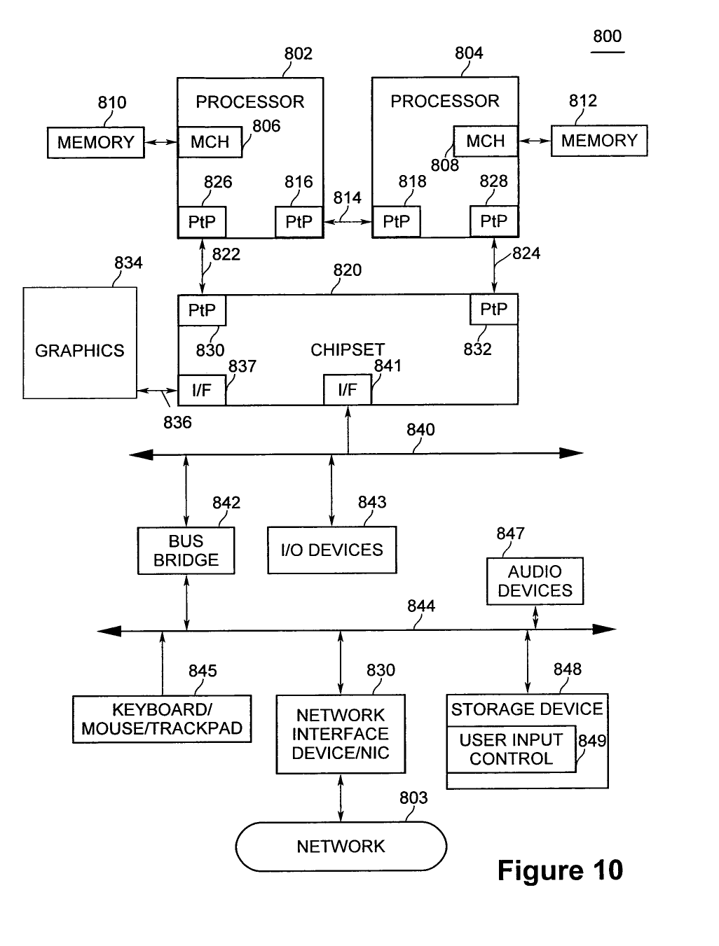

FIG. 9 illustrates a block diagram of an embodiment of a processing system 700. In various embodiments, one or more of the components of the system 700 may be provided in various electronic devices capable of performing one or more of the operations discussed herein with reference to some embodiments of the invention. For example, one or more of the components of the system 700 may be used to perform the operations discussed with reference to FIGS. 1-8, e.g., by processing instructions, executing subroutines, etc. in accordance with the operations discussed herein. Also, various storage devices discussed herein (e.g., with reference to FIG. 9 and/or FIG. 10) may be used to store data, operation results, etc. In one embodiment, data may be received over the network 703 (e.g., via network interface devices 730 and/or 830) may be stored in caches (e.g., L1 caches in an embodiment) present in processors 702 (and/or 802 of FIG. 10). These processors may then apply the operations discussed herein in accordance with various embodiments of the invention.

More particularly, the processing system 700 may include one or more central processing unit(s) 702 or processors that communicate via an interconnection network (or bus) 704. Hence, various operations discussed herein may be performed by a processor in some embodiments. Moreover, the processors 702 may include a general purpose processor, a network processor (that processes data communicated over a computer network 703, or other types of a processor (including a reduced instruction set computer (RISC) processor or a complex instruction set computer (CISC)). Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. Moreover, the operations discussed with reference to FIGS. 1-8 may be performed by one or more components of the system 700. In an embodiment, a processor (such as processor 1 702-1) may comprise user input control 116, GUI 108, and/or OS 106 as hardwired logic (e.g., circuitry) or microcode.

A chipset 706 may also communicate with the interconnection network 704. The chipset 706 may include a graphics and memory control hub (GMCH) 708. The GMCH 708 may include a memory controller 710 that communicates with a memory 712. The memory 712 may store data and/or instructions. The data may include sequences of instructions that are executed by the processor 702 or any other device included in the processing system 700. Furthermore, memory 712 may store one or more of the programs or algorithms discussed herein such as user input control 116, GUI 108, and/or OS 106, instructions corresponding to executables, mappings, etc. The same or at least a portion of this data (including instructions, and temporary storage arrays) may be stored in disk drive 728 and/or one or more caches within processors 702. In one embodiment of the invention, the memory 712 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 704, such as multiple processors and/or multiple system memories.

The GMCH 708 may also include a graphics interface 714 that communicates with touch screen display 110. In one embodiment of the invention, the graphics interface 714 may communicate with the touch screen display 110 via an accelerated graphics port (AGP). In an embodiment of the invention, the display 110 may be a flat panel display that communicates with the graphics interface 714 through, for example, a signal converter that translates a digital representation of an image stored in a storage device such as video memory or system memory into display signals that are interpreted and displayed by the display 110. The display signals produced by the interface 714 may pass through various control devices before being interpreted by and subsequently displayed on the display 110. In an embodiment, user input control 116 may be implemented as circuitry within graphics interface 714 or elsewhere within the chipset.

A hub interface 718 may allow the GMCH 708 and an input/output (I/O) control hub (ICH) 720 to communicate. The ICH 720 may provide an interface to I/O devices that communicate with the processing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the processor 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The interconnection network 722 may communicate with input devices 726 (such as a track pad, mouse, or other pointing input device, or touch screen display 110), one or more disk drive(s) 728, and a network interface device 730, which may be in communication with the computer network 703 (such as the Internet, for example). In an embodiment, the device 730 may be a network interface controller (NIC) capable of wired or wireless communication. Other devices may communicate via the bus 722. Also, various components (such as the network interface device 730) may communicate with the GMCH 708 in some embodiments of the invention. In addition, the processor 702, the GMCH 708, and/or the graphics interface 714 may be combined to form a single chip. Furthermore, the processing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

In an embodiment, components of the system 700 may be arranged in a point-to-point (PtP) configuration such as discussed with reference to FIG. 10. For example, processors, memory, and/or input/output devices may be interconnected by a number of point-to-point interfaces.

More specifically, FIG. 10 illustrates a processing system 800 that is arranged in a point-to-point (PtP) configuration, according to an embodiment of the invention. In particular, FIG. 10 shows a system where processors, memory, and input/output devices are interconnected by a number of point-to-point interfaces. The operations discussed with reference to FIGS. 1-8 may be performed by one or more components of the system 800.

As illustrated in FIG. 10, the system 800 may include multiple processors, of which only two, processors 802 and 804 are shown for clarity. The processors 802 and 804 may each include a local memory controller hub (MCH) 806 and 808 (which may be the same or similar to the GMCH 708 of FIG. 7 in some embodiments) to couple with memories 810 and 812. The memories 810 and/or 812 may store various data such as those discussed with reference to the memory 712 of FIG. 9.

The processors 802 and 804 may be any suitable processor such as those discussed with reference to processors 702 of FIG. 9. The processors 802 and 804 may exchange data via a point-to-point (PtP) interface 814 using PtP interface circuits 816 and 818, respectively. The processors 802 and 804 may each exchange data with a chipset 820 via individual PtP interfaces 822 and 824 using point to point interface circuits 826, 828, 830, and 832. The chipset 820 may also exchange data with a high-performance graphics circuit 834 via a high-performance graphics interface 836, using a PtP interface circuit 837. Graphics 824 may be coupled with a touch screen display 110 (not shown in FIG. 10).

At least one embodiment of the invention may be provided by utilizing the processors 802 and 804. For example, the processors 802 and/or 804 may perform one or more of the operations of FIGS. 1-8. Other embodiments of the invention, however, may exist in other circuits, logic units, or devices within the system 800 of FIG. 10. Furthermore, other embodiments of the invention may be distributed throughout several circuits, logic units, or devices illustrated in FIG. 8.

The chipset 820 may be coupled to a bus 840 using a PtP interface circuit 841. The bus 840 may have one or more devices coupled to it, such as a bus bridge 842 and I/O devices 843. Via a bus 844, the bus bridge 843 may be coupled to other devices such as a keyboard/mouse/track pad 845, the network interface device 730 discussed with reference to FIG. 9 (such as modems, network interface cards (NICs), or the like that may be coupled to the computer network 703), audio I/O device 847, and/or a data storage device 848. The data storage device 848 may store, in an embodiment, user input control instructions 849 that may be executed by the processors 802 and/or 804.

In various embodiments of the invention, the operations discussed herein, e.g., with reference to FIGS. 1-8, may be implemented as hardware (e.g., logic circuitry), software (including, for example, micro-code that controls the operations of a processor such as the processors discussed with reference to FIGS. 9 and 10), firmware, or combinations thereof, which may be provided as a computer program product. e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. In a processing system having a touch screen display, a method of dynamically updating a soft keyboard shown on the touch screen display comprising:
receiving user input data from a user;
when the user input data indicates a current character, predicting a likelihood of at least one next character being entered by the user, and assigning the at least one next character to a soft key of the soft keyboard based at least in part on a correlation of the likelihood of the at least one next character being entered next by the user and a distance of the soft key to a predetermined location of the soft keyboard; and
updating the soft keyboard on the touch screen display.

2. The method of claim 1, wherein the correlation comprises assigning at least one next character more likely to be entered next by the user to a soft key closer to the predetermined location of the soft keyboard than a character less likely to be entered next by the user.

3. The method of claim 1, further comprising updating the soft keyboard after every character input by the user.

4. The method of claim 2, wherein predicting a likelihood of at least one next character being entered by the user comprises determining a priority for the at least one next character based at least in part on one or more of the current character, a frequency of use of characters in a selected language, a frequency of previous use of characters by the user, a frequency of use of characters in words of a word database of the processing system, and validity of a combination of the current character and the at least one next character in the selected language.

5. The method of claim 4, further comprising assigning the at least one next character to one of a plurality of sets based on the determined priority.

6. The method of claim 5, further comprising assigning the at least one next character to a soft key of the soft keyboard based at least in part on the priority set to which the at least one next character is currently assigned.

7. The method of claim 6, wherein there are two priority sets and a distance to the center of the soft keyboard of a soft key assigned to a first priority set is less than a distance to the center of the soft keyboard of a soft key assigned to a second priority set.

8. The method of claim 6, wherein there are three priority sets and a distance to the center of the soft keyboard of a soft key assigned to a first priority set is less than a distance to the center of the soft keyboard of a soft key assigned to a second priority set, and the distance to the center of the soft keyboard of a soft key assigned to the second priority set is less than a distance to the center of the soft keyboard of a soft key assigned to a third priority set.

9. The method of claim 8, further comprising assigning most likely next characters to the first priority set, least likely next characters to the third priority set, and remaining characters to the second priority set.

10. The method of claim 6, further comprising dividing each priority set into two subsets, with a first subset of each priority set including characters assigned to soft keys on a left hand side of the soft keyboard and a second subset of each priority set including characters assigned to soft keys on a right hand side of the soft keyboard.

11. The method of claim 7, wherein soft keys of the first priority set are larger on the touch screen display than soft keys of the second priority set.

12. The method of claim 1, further comprising displaying a list of suggested words on the touch screen display.

13. The method of claim 12, further comprising when the user input data indicates a current character, determining an updated list of suggested words that the user may be trying to enter based at least in part one or more of the current character, any previously entered characters for a current word, any previously entered words for a current sentence, and a word database of the processing system.

14. The method of claim 13, further comprising displaying the updated list of suggested words on the touch screen display as part of updating the soft keyboard.

15. The method of claim 12, wherein the list of suggested words comprises most frequently used words and/or word fragments in a selected language.

16. The method of claim 12, wherein the list of suggested words comprises most frequently used words previously used by the user.

17. A processing system comprising:
a touch screen display to show a soft keyboard to a user and to receive user input data from the user;
a user input control component adapted to, when the user input data indicates a current character, predict a likelihood of at least one next character being entered by the user, to assign the at least one next character to a soft key of the soft keyboard based at least in part on a correlation of the likelihood of the at least one next character being entered next by the user and a distance of the soft key to a predetermined location of the soft keyboard; and to cause the updating of the soft keyboard on the touch screen display.

18. The processing system of claim 17, wherein the user input control component is further adapted to assign at least one next character more likely to be entered next by the user to a soft key closer to the predetermined location of the soft keyboard than a character less likely to be entered next by the user.

19. The processing system of claim 17, wherein the user input control component comprises a dynamic keyboard layout control component to update the soft keyboard after every character input by the user.

20. The processing system of claim 18, wherein the user input control component comprises a character prediction component to predict the likelihood of at least one next character being entered by the user by determining a priority for the at least one next character based at least in part on one or more of the current character, a frequency of use of characters in a selected language, a frequency of previous use of characters by the user, a frequency of use of characters in words of a word database of the processing system, and validity of a combination of the current character and the at least one next character in the selected language.

21. The processing system of claim 20, wherein the character prediction component is to assign the at least one next character to one of a plurality of sets based on the determined priority.

22. The processing system of claim 21, wherein the character prediction component is to assign the at least one next character to a soft key of the soft keyboard based at least in part on the priority set to which the at least one next character is currently assigned.

23. The processing system of claim 22, wherein there are two priority sets and a distance to the center of the soft keyboard of a soft key assigned to a first priority set is less than a distance to the center of the soft keyboard of a soft key assigned to a second priority set.

24. The processing system of claim 22, wherein there are three priority sets and a distance to the center of the soft keyboard of a soft key assigned to a first priority set is less than a distance to the center of the soft keyboard of a soft key assigned to a second priority set, and the distance to the center of the soft keyboard of a soft key assigned to the second priority set is less than a distance to the center of the soft keyboard of a soft key assigned to a third priority set.

25. The processing system of claim 24, wherein the character prediction component is to assign most likely next characters to the first priority set, least likely next characters to the third priority set, and remaining characters to the second priority set.

26. The processing system of claim 22, wherein the character prediction component is to divide each priority set into two subsets, with a first subset of each priority set including characters assigned to soft keys on a left hand side of the soft keyboard and a second subset of each priority set including characters assigned to soft keys on a right hand side of the soft keyboard.

27. The processing system of claim 23, wherein soft keys of the first priority set are larger on the touch screen display than soft keys of the second priority set.

28. The processing system of claim 17, wherein the user input control component comprises a dynamic keyboard layout control component to cause the display of a list of suggested words on the touch screen display.

29. The processing system of claim 28, wherein the user input control component comprises a word suggestion component, and wherein when the user input data indicates a current character, the word suggestion component is to determine an updated list of suggested words that the user may be trying to enter based at least in part one or more of the current character, any previously entered characters for a current word, any previously entered words for a current sentence, and a word database of the processing system.

30. The processing system of claim 29, wherein the dynamic keyboard layout control component is to cause the display of the updated list of suggested words on the touch screen display as part of updating the soft keyboard.

31. The processing system of claim 29, wherein the list of suggested words comprises most frequently used words and/or word fragments in a selected language.

32. The processing system of claim 29, wherein the list of suggested words comprises most frequently used words previously used by the user.

33. (canceled)

34. (canceled)
